(19) United States
(12) Patent Application Publication
(10) Pub. No.: US 2003/0179945 A1
(43) Pub. Date: Sep. 25, 2003

(54) Method, apparatus, and program for processing images

(76) Inventor: Sadato Akahori, Kaisei-machi (JP)

Correspondence Address: BIRCH STEWART KOLASCH & BIRCH, PO BOX 747, FALLS CHURCH, VA, 22040-0747, US

(21) Appl. No.: 10/391,741

(22) Filed: Mar. 20, 2003

(30) Foreign Application Priority Data
Mar. 20, 2002 (JP) 079335/2002

(51) Int. Cl. G06T 5/00; G06K 9/40; G06T 5/10

(52) U.S. Cl. 382/260; 382/264; 382/266; 382/275

(57) ABSTRACT

Absolute values of middle and high frequency components of an image signal are set as evaluation values. Values of gains for the middle and high frequency components are set in accordance with the evaluation values. Enhancement and suppression processing for suppressing the middle frequency components and enhancing the high frequency components is performed in accordance with the gains for the middle and high frequency components. The middle and high frequency components, which have been obtained from the enhancement and suppression processing, and the other frequency components are combined with one another, and a processed image signal is thereby formed.

### BACKGROUND OF THE INVENTION

1. Field of the Invention

This invention relates to an image processing method and apparatus, wherein image processing for suppressing roughness of an image and enhancing sharpness of the image is performed on an image signal representing the image. This invention also relates to a computer program for causing a computer to execute the image processing method, and a computer readable recording medium, on which the computer program has been recorded.

2. Description of the Related Art

There have heretofore been known systems for performing various kinds of image processing on image signals, which have been acquired with imaging devices, such as digital cameras and digital video devices, or image signals, which have been acquired by reading out images from photographic film by use of scanners, in order to obtain processed image signals, and reproducing visible images from the processed image signals by use of printers or displaying devices, such as monitors.

In particular, as for the image processing to be performed with the systems for performing the image processing on the image signals, which represent images having been recorded on photographic film, a technique for performing image processing for suppressing graininess of an image due to film graininess and enhancing the sharpness of the image has been proposed in, for example, U.S. Pat. No. 5,739,922. The proposed technique for performing the image processing comprises the steps of: (i) separating an original image signal representing an original image into low frequency components, middle frequency components, and high frequency components, (ii) performing enhancement and suppression processing, wherein the middle frequency components are suppressed by being multiplied by a gain, and the high frequency components are enhanced by being multiplied by a gain, and (iii) combining the high frequency components and the middle frequency components, which have been obtained from the enhancement and suppression processing, and the other frequency components with one another, a processed image signal being thereby obtained.

With the proposed technique for performing the image processing, the gain, by which the middle frequency components are to be multiplied, and the gain, by which the high frequency components are to be multiplied, are determined in accordance with certain evaluation values. Specifically, a correlation value between at least a single set of two colors, which are among red (R), green (G), and blue (B) three colors of each middle frequency component and each high frequency component with respect to an identical pixel is employed as each of the evaluation values.

Besides the image signal having been acquired by reading out the image having been recorded on photographic film, the image signal having been acquired with the digital camera may also be subjected to the enhancement and suppression processing, which is performed on the frequency components in the same manner as that for the image signal having been acquired by reading out the image having been recorded on photographic film, in accordance with the technique proposed in U.S. Pat. No. 5,739,922. In this manner, from the image signal having been acquired with the digital camera, a processed image signal capable of reproducing an image, in which the roughness has been suppressed, and the sharpness has been enhanced, is capable of being obtained.

In cases where the enhancement and suppression processing is to be performed on an ordinary digital image signal, and the quantity of the components of a high frequency is small with respect to color difference components as in images having been subjected to JPEG compression, the enhancement and suppression processing may be applied to only the luminance components of the image signal. In this manner, the amount of operation processing is capable of being kept small, while the roughness of the image is being suppressed, and the sharpness is being enhanced.

However, in order for the correlation values described above to be employed as the evaluation values, it is necessary that the middle frequency components and the high frequency components are formed with respect the R, G, and B three colors, and that the correlation value between at least a single set of two colors, which are among the R, G, and B three colors, is calculated with respect to an identical pixel. Therefore, a long time is required to perform the operation processing for determining the gains.

### SUMMARY OF THE INVENTION

The primary object of the present invention is to provide an image processing method, wherein image processing for suppressing roughness of an image and enhancing sharpness of the image is capable of being performed efficiently.

Another object of the present invention is to provide an apparatus for carrying out the image processing method.

A further object of the present invention is to provide a computer program for causing a computer to execute the image processing method.

A still further object of the present invention is to provide a computer readable recording medium, on which the computer program has been recorded.

The present invention provides an image processing method, comprising the steps of:

i) separating an image signal at least into low frequency components, middle frequency components, and high frequency components,

ii) setting evaluation values of the middle frequency components and evaluation values of the high frequency components after the separation,

iii) setting values of a gain for the middle frequency components, which gain acts to suppress the middle frequency components, in accordance with the evaluation values of the middle frequency components,

iv) setting values of a gain for the high frequency components, which gain acts to enhance the high frequency components, in accordance with the evaluation values of the high frequency components,

v) performing enhancement and suppression processing, with which the middle frequency components are suppressed, and the high frequency components are enhanced, in accordance with the gain for the middle frequency components and the gain for the high frequency components, and

vi) combining the middle frequency components and the high frequency components, which have been obtained from the enhancement and suppression processing, and the other frequency components with one another, a processed image signal being thereby formed,

wherein absolute values of the middle frequency components are set as the evaluation values of the middle frequency components, and

absolute values of the high frequency components are set as the evaluation values of the high frequency components.

FIG. 2 is a graph showing how low frequency components, middle frequency components, and high frequency components are distributed. The term “low frequency components, middle frequency components, and high frequency components of an image signal” as used herein means the frequency components, which are distributed in the patterns shown in, for example, FIG. 2. Specifically, the middle frequency components are distributed such that the middle frequency components may have a peak in the vicinity of ⅓ of a Nyquist frequency (in this example, 6 cycle/mm) of the output in the reproduction of a visible image from the signal having been processed. The low frequency components are distributed such that the low frequency components may have a peak at a frequency, at which the Nyquist frequency of the output becomes equal to 0. The high frequency components are distributed such that the high frequency components may have a peak at the Nyquist frequency of the output.

In the image processing method in accordance with the present invention, the image signal is separated at least into the three kinds of the frequency components, i.e. the low frequency components, the middle frequency components, and the high frequency components. Specifically, the image signal may be separated into four or more kinds of frequency components. In cases where the image signal is thus separated into four or more kinds of frequency components, the low frequency components, the middle frequency components, and the high frequency components are selected from the four or more kinds of frequency components.

The image processing method in accordance with the present invention should preferably be modified such that luminance components of the image signal are formed,

the separation, the setting of the values of the gains, the enhancement and suppression processing, and the combining are performed in accordance with the luminance components, a luminance components processed image signal being thereby obtained, and

the processed image signal is formed in accordance with the luminance components processed image signal.

Also, the image processing method in accordance with the present invention should preferably be modified such that the values of the gain for the middle frequency components are set such that, in the enhancement and suppression processing, a middle frequency component corresponding to a pixel, which is associated with the absolute value of the middle frequency component smaller than a predetermined threshold value, is more suppressed than a middle frequency component corresponding to a pixel, which is associated with the absolute value of the middle frequency component larger than the predetermined threshold value, is.

Further, the image processing method in accordance with the present invention should preferably be modified such that the values of the gain for the high frequency components are set such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

The present invention also provides an image processing apparatus, comprising:

i) separation means for separating an image signal at least into low frequency components, middle frequency components, and high frequency components,

ii) enhancement and suppression processing means for:

a) setting evaluation values of the middle frequency components and evaluation values of the high frequency components after the separation,

b) setting values of a gain for the middle frequency components, which gain acts to suppress the middle frequency components, in accordance with the evaluation values of the middle frequency components,

c) setting values of a gain for the high frequency components, which gain acts to enhance the high frequency components, in accordance with the evaluation values of the high frequency components, and

d) performing enhancement and suppression processing, with which the middle frequency components are suppressed, and the high frequency components are enhanced, in accordance with the gain for the middle frequency components and the gain for the high frequency components, and

iii) forming means for combining the middle frequency components and the high frequency components, which have been obtained from the enhancement and suppression processing, and the other frequency components with one another in order to form a processed image signal,

wherein the enhancement and suppression processing means is means for setting absolute values of the middle frequency components as the evaluation values of the middle frequency components, and setting absolute values of the high frequency components as the evaluation values of the high frequency components.

The image processing apparatus in accordance with the present invention should preferably be modified such that the apparatus further comprises luminance components forming means for forming luminance components of the image signal,

the separation means is means for performing the separation in accordance with the luminance components,

the enhancement and suppression processing means is means for performing the setting of the values of the gains and the enhancement and suppression processing in accordance with the luminance components, and

the forming means is means for performing the combining in accordance with the luminance components in order to obtain a luminance components processed image signal, and forming the processed image signal in accordance with the luminance components processed image signal.

Also, the image processing apparatus in accordance with the present invention should preferably be modified such that the enhancement and suppression processing means is means for setting the values of the gain for the middle frequency components such that, in the enhancement and suppression processing, a middle frequency component corresponding to a pixel, which is associated with the absolute value of the middle frequency component smaller than a predetermined threshold value, is more suppressed than a middle frequency component corresponding to a pixel, which is associated with the absolute value of the middle frequency component larger than the predetermined threshold value, is.

Further, the image processing apparatus in accordance with the present invention should preferably be modified such that the enhancement and suppression processing means is means for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

The present invention further provides a computer program for causing a computer to execute the image processing method in accordance with the present invention.

The present invention still further provides a computer readable recording medium, on which the computer program has been recorded.

A skilled artisan would know that the computer readable recording medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of the present invention. Additionally, computer code/instructions include, but are not limited to, source, object, and executable code and can be in any language including higher level languages, assembly language, and machine language.

With the image processing method and apparatus in accordance with the present invention, in which the enhancement and suppression processing for enhancing the high frequency components and suppressing the middle frequency components is performed in accordance with the evaluation values of the middle frequency components and evaluation values of the high frequency components, the absolute values of the middle frequency components are set as the evaluation values of the middle frequency components, and the absolute values of the high frequency components are set as the evaluation values of the high frequency components. Therefore, it is unnecessary to perform the calculation for finding a correlation value between at least a single set of two colors, which are among the R, G, and B three colors of each middle frequency component and each high frequency component with respect to an identical pixel, as in the technique proposed in Japanese Unexamined Patent Publication No. 9(1997)-22460. Accordingly, the amount of operation processing is capable of being kept small, and the processed image signal is capable of being obtained efficiently.

As for an ordinary digital image signal having been subjected to JPEG compression, it often occurs that the components of a high frequency have been lost with respect to the color difference components. However, with the image processing method and apparatus in accordance with the present invention, wherein the enhancement and suppression processing is performed only on the luminance components of the image signal, the roughness of the image is capable of being suppressed, and the sharpness is capable of being enhanced, while the amount of operation processing is being kept small.

Roughness due to film graininess appears primarily in the middle frequency components. Graininess corresponding to an area in the vicinity of a boundary between the middle frequency components and the low frequency components is particularly perceptible in the image. The signal values of the middle frequency components corresponding to the area in the vicinity of the boundary between the middle frequency components and the low frequency components take comparatively small values. Also, as for the image represented by the image signal having been acquired with the digital camera, the roughness due to signal components having comparatively small signal values and falling within the frequency band of the middle frequency components is perceptible. Therefore, the image processing method and apparatus in accordance with the present invention may be modified such that the middle frequency component corresponding to the pixel, which is associated with the absolute value of the middle frequency component smaller than the predetermined threshold value and is therefore regarded as being a pixel corresponding to the particularly perceptible roughness, is more suppressed than the middle frequency component corresponding to the pixel, which is associated with the absolute value of the middle frequency component larger than the predetermined threshold value, is. With the modification described above, the suppression of the perceptible roughness is capable of being performed efficiently.

Also, in the cases of the image signal having been acquired by reading out the image recorded on photographic film and the image signal having been acquired with the digital camera, signal components having small signal values and falling within the frequency band of the high frequency components and the frequency band of the middle frequency components are apt to constitute the roughness. Therefore, the image processing method and apparatus in accordance with the present invention may be modified such that the high frequency component corresponding to the pixel, which is associated with the absolute value of the high frequency component smaller than the predetermined threshold value, is less enhanced than the high frequency component corresponding to the pixel, which is associated with the absolute value of the high frequency component larger than the predetermined threshold value, is. With the modification described above, the problems are capable of being prevented from occurring in that the roughness is enhanced simultaneously with the enhancement of the sharpness.

### BRIEF DESCRIPTION OF THE DRAWINGS

FIG. 1 is a block diagram showing an embodiment of the image processing apparatus in accordance with the present invention,

FIG. 2 is a graph showing how low frequency components, middle frequency components, and high frequency components are distributed,

FIG. 3 is a graph showing a table for setting values of a gain of middle frequency components,

FIG. 4 is a graph showing a table for setting values of a gain of high frequency components, and

FIG. 5 is a flow chart showing how the embodiment of the image processing apparatus in accordance with the present invention operates.

### DESCRIPTION OF THE PREFERRED EMBODIMENTS

The present invention will hereinbelow be described in further detail with reference to the accompanying drawings.

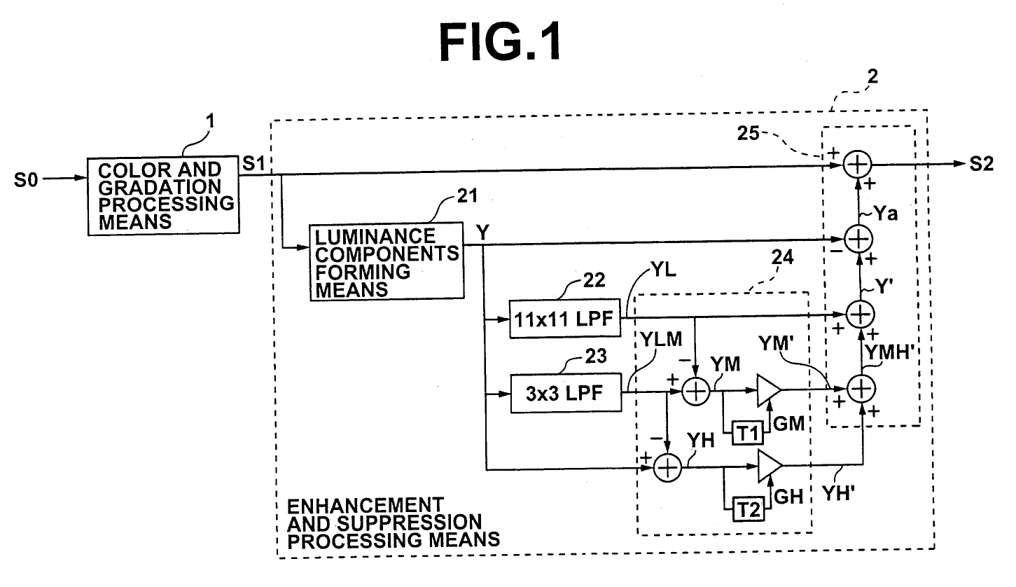

FIG. 1 is a block diagram showing an embodiment of the image processing apparatus in accordance with the present invention.

With reference to FIG. 1, this embodiment of the image processing apparatus in accordance with the present invention performs image processing on an image signal S0, which has been acquired by reading out an image recorded on negative film or reversal film by use of read-out means, such as a film scanner, and is composed of R, G, and B three color components, or on an image signal S0, which has been acquired with a digital camera. The image processing apparatus comprises color and gradation processing means 1 for performing color processing and gradation processing on the image signal S0 in order to obtain a color and gradation processed image signal S1. The image processing apparatus also comprises enhancement and suppression processing means 2 for performing graininess suppression processing and sharpness enhancement processing on the color and gradation processed image signal S1 in order to obtain a processed image signal S2.

The color and gradation processing means 1 adjusts parameters for the color processing and the gradation processing, which are to be performed on the image signal S0, in accordance with the image signal S0. Also, the color and gradation processing means 1 performs the color processing and the gradation processing on the image signal S0 by use of the adjusted parameters in order to obtain the color and gradation processed image signal S1.

The enhancement and suppression processing means 2 comprises luminance components forming means 21 for forming luminance components Y from the R, G, and B three color signal components constituting the color and gradation processed image signal S1. The enhancement and suppression processing means 2 also comprises filtering means 22 for performing filtering processing on the luminance components Y by use of a 11×11 low-pass filter (LPF) in order to obtain low frequency components YL of the luminance components Y. The enhancement and suppression processing means 2 further comprises filtering means 23 for performing filtering processing on the luminance components Y by use of a 3×3 low-pass filter (LPF) in order to obtain low and middle frequency components YLM of the luminance components Y. The enhancement and suppression processing means 2 still further comprises gain processing means 24 for forming middle frequency components YM and high frequency components YH of the luminance components Y and performing gain processing on the middle frequency components YM and the high frequency components YH in order to obtain gain-processed middle frequency components YM′ and gain-processed high frequency components YH′. The enhancement and suppression processing means 2 also comprises forming means 25 for forming the processed image signal S2 from the gain-processed middle frequency components YM′ and the gain-processed high frequency components YH′.

The luminance components forming means 21 performs the operation processing, which is represented by Formula (1) shown below, on R color signal components R1, G color signal components G1, and B color signal components B1 constituting the color and gradation processed image signal S1 in order to form the luminance components Y.

Y=0.3R1+0.59G1+0.11B1 (1)

The gain processing means 24 subtracts the low frequency components YL, which have been obtained from the filtering means 22, from the low and middle frequency components YLM, which have been obtained from the filtering means 23, in order to form the middle frequency components YM. The subtraction is performed with Formula (2) shown below. Also, the gain processing means 24 subtracts the low and middle frequency components YLM from the luminance components Y in order to form the high frequency components YH. The subtraction is performed with Formula (3) shown below.

YM=YLM−YL (2)

YH=Y−YLM (3)

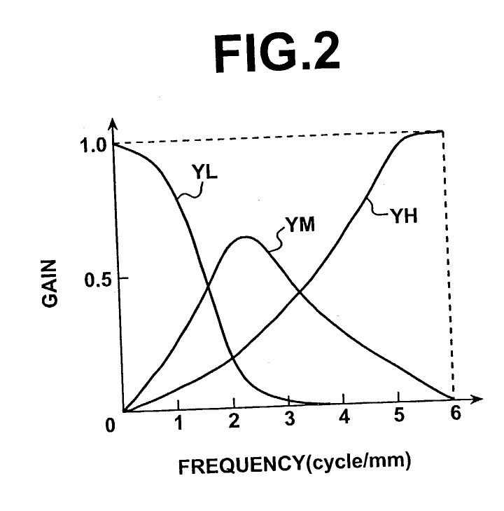

The low frequency components YL, the middle frequency components YM, and the high frequency components YH are the frequency components, which are distributed in the patterns shown in FIG. 2. Specifically, the middle frequency components YM are distributed such that the middle frequency components YM may have a peak in the vicinity of ⅓ of the Nyquist frequency (in this example, 6 cycle/mm) of the output in the reproduction of a visible image from the processed image signal S2. The low frequency components YL are distributed such that the low frequency components YL may have a peak at a frequency, at which the Nyquist frequency of the output becomes equal to 0. The high frequency components YH are distributed such that the high frequency components YH may have a peak at the Nyquist frequency of the output.

Further, the gain processing means 24 multiplies the middle frequency components YM by a gain GM, which acts to suppress the middle frequency components YM, in order to obtain the gain-processed middle frequency components YM′. The multiplication is performed with Formula (4) shown below. Furthermore, the gain processing means 24 multiplies the high frequency components YH by a gain GH, which acts to enhance the high frequency components YH, in order to obtain the gain-processed high frequency components YH′. The multiplication is performed with Formula (5) shown below.

YM′=YM×GM (4)

YH′=YH×GH (5)

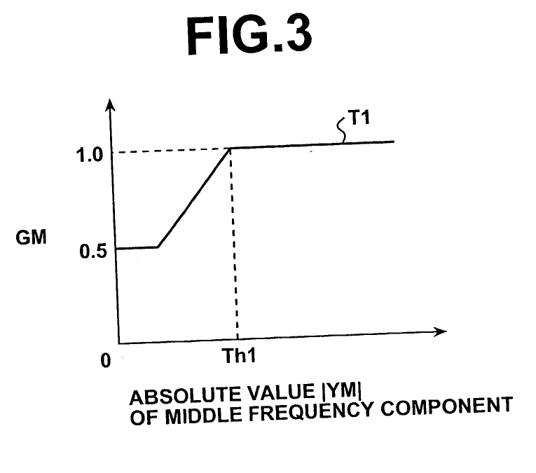

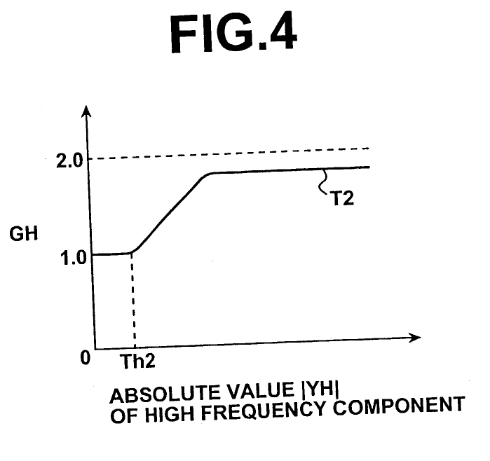

Values of the gain GM are set in accordance with absolute values |YM| of the middle frequency components YM. Also, values of the gain GH are set in accordance with absolute values |YH| of the high frequency components YH. FIG. 3 is a graph showing a table T1 representing relationship between the absolute values |YM| of the middle frequency components YM and the values of the gain GM. FIG. 4 is a graph showing a table T2 representing relationship between the absolute values |YH| of the high frequency components YH and the values of the gain GH.

As illustrated in FIG. 3, the values of the gain GM are set such that a middle frequency component YM corresponding to a pixel, which is associated with the absolute value |YM| of the middle frequency component YM smaller than a predetermined threshold value Th1, is more suppressed than a middle frequency component YM corresponding to a pixel, which is associated with the absolute value |YM| of the middle frequency component YM larger than the predetermined threshold value Th1, is.

In cases where the image signal S0 is the image signal having been acquired by reading out the image recorded on photographic film, the roughness due to film graininess appears primarily in the middle frequency components YM of the image. Graininess corresponding to an area in the vicinity of a boundary between the middle frequency components YM and the low frequency components YL is particularly perceptible in the image. The absolute values |YM| of the middle frequency components YM corresponding to the area in the vicinity of the boundary between the middle frequency components YM and the low frequency components YL take comparatively small values. Also, as for the image represented by the image signal S0 having been acquired with the digital camera, the roughness due to signal components having comparatively small signal values and falling within the frequency band of the middle frequency components YM is perceptible. Therefore, in this embodiment, wherein the middle frequency components YM are suppressed, the middle frequency component YM corresponding to the pixel, which is associated with the absolute value |YM| of the middle frequency component YM smaller than the predetermined threshold value Th1 and is therefore regarded as being a pixel corresponding to the particularly perceptible roughness, is more suppressed than the middle frequency component YM corresponding to the pixel, which is associated with the absolute value |YM| of the middle frequency component YM larger than the predetermined threshold value Th1, is. In this manner, the suppression of the perceptible roughness is capable of being performed efficiently.

Also, as illustrated in FIG. 4, the values of the gain GH are set such that a high frequency component YH corresponding to a pixel, which is associated with the absolute value |YH| of the high frequency component YH smaller than a predetermined threshold value Th2, is less enhanced than a high frequency component YH corresponding to a pixel, which is associated with the absolute value |YH| of the high frequency component YH larger than the predetermined threshold value Th2, is.

In the cases of the image signal S0 having been acquired by reading out the image recorded on photographic film and the image signal S0 having been acquired with the digital camera, signal components having small signal values and falling within the frequency band of the high frequency components YH and the frequency band of the middle frequency components YM are apt to constitute the roughness. Therefore, in this embodiment, wherein the high frequency components YH are enhanced, the high frequency component YH corresponding to the pixel, which is associated with the absolute value |YH| of the high frequency component YH smaller than the predetermined threshold value Th2, is less enhanced than the high frequency component YH corresponding to the pixel, which is associated with the absolute value |YH| of the high frequency component YH larger than the predetermined threshold value Th2, is. In this manner, the problems are capable of being prevented from occurring in that the roughness is enhanced simultaneously with the enhancement of the sharpness.

Reference is made to the table T1, and the values of the gain GM are set in accordance with the absolute values |YM| of the middle frequency components YM. Also, reference is made to the table T2, and the values of the gain GH are set in accordance with the absolute values |YH| of the high frequency components YH.

The forming means 25 adds the gain-processed middle frequency components YM′ and the gain-processed high frequency components YH′ to each other in order to obtain processed middle and high frequency components YMH′. The addition is performed with Formula (6) shown below.

YMH′=YM′+YH′ (6)

Also, the forming means 25 adds the processed middle and high frequency components YMH′ and the low frequency components YL to each other in order to obtain processed luminance components Y′. The addition is performed with Formula (7) shown below.

Y′=YMH′+YL (7)

Further, the forming means 25 subtracts the luminance components Y from the processed luminance components Y′ in order to obtain addition components Ya. The subtraction is performed with Formula (8) shown below.

Ya=Y′−Y (8)

Furthermore, the forming means 25 adds the addition components Ya and image signal components of the color and gradation processed image signal S1 to each other in order to obtain the processed image signal S2. Specifically, the addition components Ya and the R color signal components R1 constituting the color and gradation processed image signal S1 are added to each other, and R color signal components R2 constituting the processed image signal S2 are thereby obtained. Also, the addition components Ya and the G color signal components G1 constituting the color and gradation processed image signal S1 are added to each other, and G color signal components G2constituting the processed image signal S2 are thereby obtained. Further, the addition components Ya and the B color signal components B1 constituting the color and gradation processed image signal S1 are added to each other, and B color signal components B2 constituting the processed image signal S2 are thereby obtained. The additions are performed with Formula (9) shown below.

R2=R1+Ya

G2=G1+Ya (9)

B2=B1+Ya

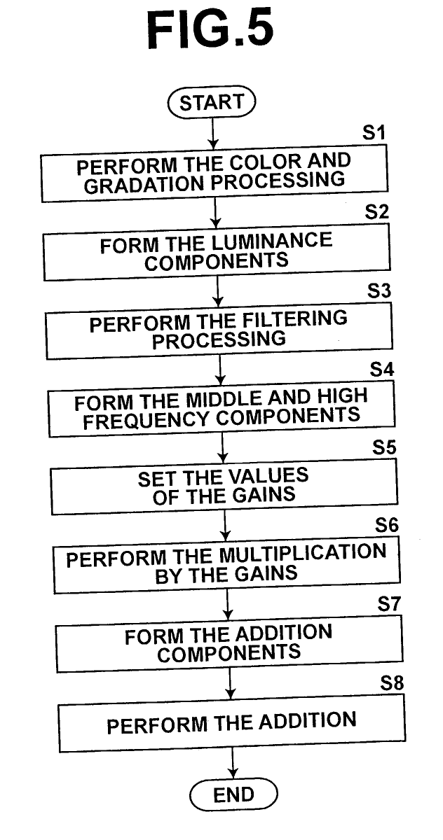

How the embodiment of the image processing apparatus in accordance with the present invention operates will be described herein below with reference to FIG. 5. FIG. 5 is a flowchart showing how the embodiment of the image processing apparatus in accordance with the present invention operates.

Firstly, in a step S1, the color and gradation processing is performed by the color and gradation processing means 1 on the image signal S0, and the color and gradation processed image signals list here by obtained. The color and gradation processed image signal S1 is fed into the enhancement and suppression processing means 2. In a step S2, the luminance components Y of the color and gradation processed image signal S1 are formed by the luminance components forming means 21. Also, in a step S3, the luminance components Y are subjected by the filtering means 22 to the filtering processing with the 11×11 low-pass filter, and the low frequency components YL of the luminance components Y are thereby obtained. Further, the luminance components Y are subjected by the filtering means 23 to the filtering processing with the 3×3 low-pass filter, and the low and middle frequency components YLM of the luminance components Y are thereby obtained.

Thereafter, the gain processing is performed by the gain processing means 24 in the manner described below. Specifically, in a step S4, the middle frequency components YM and the high frequency components YH are formed from the luminance components Y, the low frequency components YL, and the low and middle frequency components YLM. Also, in a step S5, the values of the gain GM are set in accordance with the absolute values |YM| of the middle frequency components YM, and the values of the gain GH are set in accordance with the absolute values |YH| of the high frequency components YH. Further, in a step S6, the middle frequency components YM are multiplied by the gain GM, and the gain-processed middle frequency components YM′ are thereby obtained. Also, in the step S6, the high frequency components YH are multiplied by the gain GH, and the gain-processed high frequency components YH′ are thereby obtained.

Thereafter, the processing is performed by the forming means 25 in the manner described below. Specifically, in a step S7, the addition components Ya are formed in accordance with the gain-processed middle frequency components YM′, the gain-processed high frequency components YH′, the low frequency components YL, and the luminance components Y. Also, in a step S8, the addition components Ya are added to the image signal components of the color and gradation processed image signal S1, and the processed image signal S2 is thereby formed. At this stage, the processing is finished. The processed image signal S2 is fed into a monitor or a printer and utilized for reproducing a visible image.

As described above, with this embodiment of the image processing apparatus in accordance with the present invention, the processing is performed such that the middle frequency components YM are suppressed, and the high frequency components YH are enhanced. Therefore, a processed image, in which the sharpness has been enhanced, and the roughness has been suppressed, is capable of being obtained by being reproduced from the processed image signal S2.

In particular, with this embodiment of the image processing apparatus in accordance with the present invention, as the evaluation values for adjusting the values of the gain GM and the gain GH, the absolute values |YM| of the middle frequency components YM and the absolute values |YH| of the high frequency components YH are respectively employed. Therefore, in order for each of the evaluation values for adjusting the values of the gain GM and the gain GH to be calculated, it is unnecessary to perform the calculation for finding a correlation value between at least a single set of two colors, which are among the R, G, and B three colors of each middle frequency component and each high frequency component with respect to an identical pixel, as in the technique proposed in Japanese Unexamined Patent Publication No. 9(1997)-22460. Accordingly, the amount of operation processing is capable of being kept small, and the processed image signal is capable of being obtained efficiently.

Also, as for an ordinary digital image signal having been subjected to JPEG compression, it often occurs that the components of a high frequency have been lost with respect to the color difference components. However, with the embodiment of the image processing apparatus in accordance with the present invention, wherein the enhancement and suppression processing is performed only on the luminance components Y of the color and gradation processed image signal S1, the roughness of the image is capable of being suppressed, and the sharpness is capable of being enhanced, while the amount of operation processing is being kept small.

In the aforesaid embodiment, the luminance components Y are separated into the three kinds of the frequency components, i.e. the low frequency components YL, the middle frequency components YM, and the high frequency components YH. Alternatively, the luminance components Y may be separated into four or more kinds of frequency components. In cases where the luminance components Y are thus separated into four or more kinds of frequency components, the low frequency components, the middle frequency components, and the high frequency components are selected from the four or more kinds of frequency components.

Also, in the aforesaid embodiment, the luminance components Y are formed from the color and gradation processed image signal S1, and the middle frequency components YM and the high frequency components YH of the luminance components Y are multiplied respectively by the gain GM and the gain GH. Alternatively, middle frequency components RM, GM, BM and high frequency components RH, GH, BH of the R color signal components R1, G color signal components G1, and B color signal components B1 constituting the color and gradation processed image signal S1 may be formed. Also, gain-processed middle frequency components RM′, GM′, BM′ and gain-processed high frequency components RH′, GH′, BH′ may be formed respectively for the three colors. In this manner, the processed image signal S2 may be formed. In such cases, the values of the gain, by which the middle frequency components RM, GM, BM are to be multiplied, are set in accordance with the absolute values of the middle frequency components RM, GM, BM. Also, the values of the gain, by which the high frequency components RH, GH, BH are to be multiplied, are set in accordance with the absolute values of the high frequency components RH, GH, BH.

Further, in the aforesaid embodiment, the image signal S0 composed of the R, G, and B three color components is processed. However, the processing for suppressing the graininess and enhancing the sharpness is capable of being performed also on an image signal S0 composed of signal components on a standard color space, such as a YCC color space or an L*a*b* color space. On the standard color space, the luminance components are obtained as already formed components. Therefore, by use of the already formed luminance components, the processing is capable of being performed without a particular operation being required to form the luminance components from the image signal S0.

What is claimed is:

1. An image processing method, comprising the steps of:
i) separating an image signal at least into low frequency components, middle frequency components, and high frequency components,
ii) setting evaluation values of the middle frequency components and evaluation values of the high frequency components after the separation,
iii) setting values of a gain for the middle frequency components, which gain acts to suppress the middle frequency components, in accordance with the evaluation values of the middle frequency components,
iv) setting values of a gain for the high frequency components, which gain acts to enhance the high frequency components, in accordance with the evaluation values of the high frequency components,
v) performing enhancement and suppression processing, with which the middle frequency components are suppressed, and the high frequency components are enhanced, in accordance with the gain for the middle frequency components and the gain for the high frequency components, and
vi) combining the middle frequency components and the high frequency components, which have been obtained from the enhancement and suppression processing, and the other frequency components with one another, a processed image signal being thereby formed,
wherein absolute values of the middle frequency components are set as the evaluation values of the middle frequency components, and
absolute values of the high frequency components are set as the evaluation values of the high frequency components.

2. A method as defined in claim 1 wherein the values of the gain for the middle frequency components are set such that, in the enhancement and suppression processing, a middle frequency component corresponding to a pixel, which is associated with the absolute value of the middle frequency component smaller than a predetermined threshold value, is more suppressed than a middle frequency component corresponding to a pixel, which is associated with the absolute value of the middle frequency component larger than the predetermined threshold value, is.

3. A method as defined in claim 1 wherein the values of the gain for the high frequency components are set such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

4. A method as defined in claim 2 wherein the values of the gain for the high frequency components are set such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

5. A method as defined in claim 1 wherein luminance components of the image signal are formed, the separation, the setting of the values of the gains, the enhancement and suppression processing, and the combining are performed in accordance with the luminance components, a luminance components processed image signal being thereby obtained, and
the processed image signal is formed in accordance with the luminance components processed image signal.

6. A method as defined in claim 2 wherein luminance components of the image signal are formed,
the separation, the setting of the values of the gains, the enhancement and suppression processing, and the combining are performed in accordance with the luminance components, a luminance components processed image signal being thereby obtained, and
the processed image signal is formed in accordance with the luminance components processed image signal.

7. A method as defined in claim 3 wherein luminance components of the image signal are formed,
the separation, the setting of the values of the gains, the enhancement and suppression processing, and the combining are performed in accordance with the luminance components, a luminance components processed image signal being thereby obtained, and
the processed image signal is formed in accordance with the luminance components processed image signal.

8. A method as defined in claim 4 wherein luminance components of the image signal are formed,
the separation, the setting of the values of the gains, the enhancement and suppression processing, and the combining are performed in accordance with the luminance components, a luminance components processed image signal being thereby obtained, and
the processed image signal is formed in accordance with the luminance components processed image signal.

9. An image processing apparatus, comprising:
i) separation means for separating an image signal at least into low frequency components, middle frequency components, and high frequency components,
ii) enhancement and suppression processing means for:
a) setting evaluation values of the middle frequency components and evaluation values of the high frequency components after the separation,
b) setting values of a gain for the middle frequency components, which gain acts to suppress the middle frequency components, in accordance with the evaluation values of the middle frequency components,
c) setting values of a gain for the high frequency components, which gain acts to enhance the high frequency components, in accordance with the evaluation values of the high frequency components, and
d) performing enhancement and suppression processing, with which the middle frequency components are suppressed, and the high frequency components are enhanced, in accordance with the gain for the middle frequency components and the gain for the high frequency components, and
iii) forming means for combining the middle frequency components and the high frequency components, which have been obtained from the enhancement and suppression processing, and the other frequency components with one another in order to form a processed image signal,
wherein the enhancement and suppression processing means is means for setting absolute values of the middle frequency components as the evaluation values of the middle frequency components, and setting absolute values of the high frequency components as the evaluation values of the high frequency components.

10. An apparatus as defined in claim 9 wherein the enhancement and suppression processing means is means for setting the values of the gain for the middle frequency components such that, in the enhancement and suppression processing, a middle frequency component corresponding to a pixel, which is associated with the absolute value of the middle frequency component smaller than a predetermined threshold value, is more suppressed than a middle frequency component corresponding to a pixel, which is associated with the absolute value of the middle frequency component larger than the predetermined threshold value, is.

11. An apparatus as defined in claim 9 wherein the enhancement and suppression processing means is means for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

12. An apparatus as defined in claim 10 wherein the enhancement and suppression processing means is means for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

13. An apparatus as defined in claim 9 where in the apparatus further comprises luminance components forming means for forming luminance components of the image signal,
the separation means is means for performing the separation in accordance with the luminance components,
the enhancement and suppression processing means is means for performing the setting of the values of the gains and the enhancement and suppression processing in accordance with the luminance components, and
the forming means is means for performing the combining in accordance with the luminance components in order to obtain a luminance components processed image signal, and forming the processed image signal in accordance with the luminance components processed image signal.

14. An apparatus as defined in claim 10 wherein the apparatus further comprises luminance components forming means for forming luminance components of the image signal,
the separation means is means for performing the separation in accordance with the luminance components,
the enhancement and suppression processing means is means for performing the setting of the values of the gains and the enhancement and suppression processing in accordance with the luminance components, and
the forming means is means for performing the combining in accordance with the luminance components in order to obtain a luminance components processed image signal, and forming the processed image signal in accordance with the luminance components processed image signal.

15. An apparatus as defined in claim 11 wherein the apparatus further comprises luminance components forming means for forming luminance components of the image signal,
the separation means is means for performing the separation in accordance with the luminance components,
the enhancement and suppression processing means is means for performing the setting of the values of the gains and the enhancement and suppression processing in accordance with the luminance components, and
the forming means is means for performing the combining in accordance with the luminance components in order to obtain a luminance components processed image signal, and forming the processed image signal in accordance with the luminance components processed image signal.

16. An apparatus as defined in claim 12 wherein the apparatus further comprises luminance components forming means for forming luminance components of the image signal,
the separation means is means for performing the separation in accordance with the luminance components,
the enhancement and suppression processing means is means for performing the setting of the values of the gains and the enhancement and suppression processing in accordance with the luminance components, and
the forming means is means for performing the combining in accordance with the luminance components in order to obtain a luminance components processed image signal, and forming the processed image signal in accordance with the luminance components processed image signal.

17. A computer program for causing a computer to execute an image processing method, the computer program comprising the procedures for:
i) separating an image signal at least into low frequency components, middle frequency components, and high frequency components,
ii) setting evaluation values of the middle frequency components and evaluation values of the high frequency components after the separation, setting values of a gain for the middle frequency components, which gain acts to suppress the middle frequency components, in accordance with the evaluation values of the middle frequency components, and setting values of a gain for the high frequency components, which gain acts to enhance the high frequency components, in accordance with the evaluation values of the high frequency components,
iii) performing enhancement and suppression processing, with which the middle frequency components are suppressed, and the high frequency components are enhanced, in accordance with the gain for the middle frequency components and the gain for the high frequency components, and
iv) combining the middle frequency components and the high frequency components, which have been obtained from the enhancement and suppression processing, and the other frequency components with one another in order to form a processed image signal,
wherein the procedure for setting the values of the gains is the procedure for setting absolute values of the middle frequency components as the evaluation values of the middle frequency components, and setting absolute values of the high frequency components as the evaluation values of the high frequency components.

18. A computer program as defined in claim 17 wherein the procedure for setting the values of the gains is the procedure for setting the values of the gain for the middle frequency components such that, in the enhancement and suppression processing, a middle frequency component corresponding to a pixel, which is associated with the absolute value of the middle frequency component smaller than a predetermined threshold value, is more suppressed than a middle frequency component corresponding to a pixel, which is associated with the absolute value of the middle frequency component larger than the predetermined threshold value, is.

19. A computer program as defined in claim 17 wherein the procedure for setting the values of the gains is the procedure for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

20. A computer program as defined in claim 18 wherein the procedure for setting the values of the gains is the procedure for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

21. A computer program as defined in claim 17 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

22. A computer program as defined in claim 18 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

23. A computer program as defined in claim 19 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

24. A computer program as defined in claim 20 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

25. A computer readable recording medium, on which a computer program for causing a computer to execute an image processing method has been recorded and from which the computer is capable of reading the computer program,
wherein the computer program comprises the procedures for:
i) separating an image signal at least into low frequency components, middle frequency components, and high frequency components,
ii) setting evaluation values of the middle frequency components and evaluation values of the high frequency components after the separation, setting values of a gain for the middle frequency components, which gain acts to suppress the middle frequency components, in accordance with the evaluation values of the middle frequency components, and setting values of a gain for the high frequency components, which gain acts to enhance the high frequency components, in accordance with the evaluation values of the high frequency components,
iii) performing enhancement and suppression processing, with which the middle frequency components are suppressed, and the high frequency components are enhanced, in accordance with the gain for the middle frequency components and the gain for the high frequency components, and
iv) combining the middle frequency components and the high frequency components, which have been obtained from the enhancement and suppression processing, and the other frequency components with one another in order to form a processed image signal,
the procedure for setting the values of the gains being the procedure for setting absolute values of the middle frequency components as the evaluation values of the middle frequency components, and setting absolute values of the high frequency components as the evaluation values of the high frequency components.

26. A computer readable recording medium as defined in claim 25 wherein the procedure for setting the values of the gains is the procedure for setting the values of the gain for the middle frequency components such that, in the enhancement and suppression processing, a middle frequency component corresponding to a pixel, which is associated with the absolute value of the middle frequency component smaller than a predetermined threshold value, is more suppressed than a middle frequency component corresponding to a pixel, which is associated with the absolute value of the middle frequency component larger than the predetermined threshold value, is.

27. A computer readable recording medium as defined in claim 25 wherein the procedure for setting the values of the gains is the procedure for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

28. A computer readable recording medium as defined in claim 26 wherein the procedure for setting the values of the gains is the procedure for setting the values of the gain for the high frequency components such that, in the enhancement and suppression processing, a high frequency component corresponding to a pixel, which is associated with the absolute value of the high frequency component smaller than a predetermined threshold value, is less enhanced than a high frequency component corresponding to a pixel, which is associated with the absolute value of the high frequency component larger than the predetermined threshold value, is.

29. A computer readable recording medium as defined in claim 25 wherein the computer program further comprises the procedure for forming luminance components of the image signal, p1 the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

30. A computer readable recording medium as defined in claim 26 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

31. A computer readable recording medium as defined in claim 27 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.

32. A computer readable recording medium as defined in claim 28 wherein the computer program further comprises the procedure for forming luminance components of the image signal,
the procedure for separating the image signal is the procedure for performing the separation in accordance with the luminance components,
the procedure for setting the values of the gains is the procedure for performing the setting of the evaluation values and the setting of the values of the gains in accordance with the luminance components,
the procedure for performing the enhancement and suppression processing is the procedure for performing the enhancement and suppression processing in accordance with the luminance components, and
the procedure for forming the processed image signal is the procedure for performing the combining in accordance with the luminance components in order to obtain a luminance components processed image signal, and forming the processed image signal in accordance with the luminance components processed image signal.
